(19) United States
(12) Patent Application Publication
(10) Pub. No.: US 2026/0095061 A1
(43) Pub. Date: Apr. 2, 2026

(54) DISCHARGING DEVICE, CHARGING/DISCHARGING SYSTEM, AND METHOD OF OPERATING THE SAME

(71) Applicant: DELTA ELECTRONICS, INC., Taoyuan City (TW)

(72) Inventor: Ren-Chin SHR, Taoyuan City (TW)

(21) Appl. No.: 19/201,115

(22) Filed: May 7, 2025

(30) Foreign Application Priority Data
Sep. 30, 2024 (CN) 202411383423.6

(51) Int. Cl. H02J 7/00; H01M 10/44

(52) U.S. Cl. CPC H02J 7/96; H01M 10/44; H02J 7/40; H02J 7/54; H02J 7/663; H02J 7/855

(57) ABSTRACT

A discharging device includes an energy storage component and a load unit. The energy storage component is charged in a constant-current manner. When a voltage of the energy storage component reaches a reference voltage, the load unit is enabled to discharge the energy storage component to a fixed voltage in a constant-voltage manner.

### BACKGROUND

### Technical Field

The present disclosure relates to a discharging device, a charging/discharging system having the discharging device, and a method of operating the same, and more particularly to a discharging device that is first charged in a constant-current manner and is then discharged in a constant-voltage manner, a charging/discharging system having the discharging device, and a method of operating the same.

### Description of Related Art

The statements in this section merely provide background information related to the present disclosure and do not necessarily constitute prior art.

There are many battery applications that require accurate control of the target battery voltage and reduction of voltage differences between individuals.

Please refer to FIG. 1, which shows a schematic waveform diagram of charging a battery in a constant-current manner and a constant-voltage manner. Individual charging is performed with an independent charger, using constant-current (CC) and constant-voltage (CV) charging manners without any series or parallel connection. However, when charging is completed, due to the dissipation of the surface charge of the battery electrode, the rebalancing of the lithium ion concentration inside the battery, or self-discharge, the battery voltage usually drops, as the phenomenon shown after time t3′ in FIG. 1.

However, the CC charging manner and the CV charging manner have the following disadvantages. 1. Series charging is not possible. Due to individual differences in batteries, CV charging manner cannot be performed when connected in series. As a result, production capacity cannot be increased through series connection. 2. The CV charging manner is time-consuming. At this stage, charging needs to be stopped when charging reaches a low current to reduce the aforementioned voltage drop phenomenon and stabilize the battery voltage, thereby greatly affecting the production line capacity.

Therefore, how to design a discharging device, a charging/discharging system, and a method of operating the same to solve the problems and technical bottlenecks in the existing technology has become a critical topic in this field.

### SUMMARY

An objective of the present disclosure is to provide a discharging device, and the discharging device includes an energy storage component and a load unit. The load unit is coupled to the energy storage component. The energy storage component is charged in a constant-current manner, and when a voltage of the energy storage component reaches a reference voltage, the load unit is enabled to discharge the energy storage component to a fixed voltage in a constant-voltage manner.

In one embodiment, the discharging device further includes a switch, a controller, and an isolated communication component. The switch is connected to the energy storage component in series to form a first series-connected branch. The load unit is connected to the first series-connected branch in parallel, or is connected to the energy storage component in parallel. The controller is coupled to the switch. The isolated communication component is connected to the controller, and the isolated communication component receives an external control signal. The controller turns on the switch according to the external control signal so that the energy storage component is charged in the constant-current manner.

In one embodiment, the energy storage component is charged by a power supply.

In one embodiment, after the energy storage component is charged in the constant-current manner for a time period, when the voltage of the energy storage component reaches the reference voltage corresponding to the discharging device, the load unit is enabled to charge or discharge the energy storage component in the constant-voltage manner at the fixed voltage.

In one embodiment, when the voltage of the energy storage component reaches the reference voltage, the load unit is enabled to discharge the energy storage component to the fixed voltage in a constant-current manner instead of the constant-voltage manner.

In one embodiment, the controller generates a first control signal to control the switch.

In one embodiment, the discharging device further includes a connector. The connector is connected to the power supply and the energy storage component.

In one embodiment, during the energy storage component charged in the constant-current manner, the voltage of the energy storage component is less than a fully-charged voltage of the energy storage component.

In one embodiment, the load unit includes a switch component, a resistor component, and a feedback control unit. The resistor component is connected to the switch component in series. The feedback control unit is connected to the switch component, and generates a load control signal to control the switch component.

In one embodiment, the feedback control unit receives the voltage of the energy storage component and the reference voltage, and compares the voltage with the reference voltage. The load control signal controls an impedance of the switch component to maintain the voltage of the energy storage component at a constant value.

In one embodiment, the discharging device further includes a bypass switch. The bypass switch is connected to the first series-connected branch in parallel. When the bypass switch is turned on and the switch is turned off, the bypass switch bypasses charging the energy storage component.

In one embodiment, the controller generates a second control signal to control the bypass switch.

Therefore, the discharging device has the following features and advantages. 1. The output voltage of the battery can be accurately achieved through the constant-current charging manner and the constant-voltage discharging manner provided by the load unit. 2. The time required to charge batteries with similar characteristics from the same batch to a fixed voltage range can be shortened. 3. The switch and the bypass switch are first control to charge the energy storage component with lower power. Until the remaining battery capacities of the batteries are the same or similar (for example, the difference is less than 0.5%), the charging and discharging control can be then performed for the whole batteries to achieve energy saving effect. 4. The operation method of charging and then discharging a large number of batteries according to the present disclosure can achieve the same or higher output voltage concentration (i.e., reduce the voltage difference between batteries) in a shorter time than the traditional CC charging plus CV charging process, thereby reducing the time required to charge the battery to a fixed voltage.

Another objective of the present disclosure is to provide a discharging system. The discharging system includes a plurality of discharging devices and a plurality of energy storage components connected in series with each other. Each discharging device discharges each energy storage component. Each discharging device includes a switch, a load unit, a controller, and an isolated communication component. The switch is connected to the energy storage component in series to form a first series-connected branch. The load unit is connected to the first series-connected branch in parallel, or connected to the energy storage component in parallel. The controller is coupled to the switch. The isolated communication component is connected to the controller, and the isolated communication component receives an external control signal. The controller turns on the switch according to the external control signal so that the energy storage component is charged in a constant-current manner, and when a voltage of the energy storage component reaches a reference voltage, the load unit is enabled to discharge the energy storage component to a fixed voltage in a constant-voltage manner.

In one embodiment, the energy storage component is charged by a power supply.

In one embodiment, after each energy storage component is charged in the constant-current manner for a time period, when the voltage of each energy storage component reaches the reference voltage corresponding to the discharging device, the load unit is enabled to charge or discharge the energy storage component in the constant-voltage manner at the fixed voltage.

In one embodiment, when the voltage of the energy storage component reaches the reference voltage, the load unit is enabled to discharge the energy storage component to the fixed voltage in a constant-current manner instead of the constant-voltage manner.

In one embodiment, each discharging device further two connectors. One of the two connectors is connected to the power supply and the energy storage component, and the other of the two connectors is connected to other discharging devices.

In one embodiment, during the energy storage component charged in the constant-current manner, the voltage of the energy storage component is less than a fully-charged voltage of the energy storage component.

In one embodiment, each load unit includes a switch component, a resistor component, and a feedback control unit. The resistor component is connected to the switch component in series. The feedback control unit is connected to the switch component, and generates a load control signal to control the switch component.

In one embodiment, the feedback control unit receive the voltage of the energy storage component and the reference voltage, and compares the voltage with the reference voltage. The load control signal controls an impedance of the switch component to maintain the voltage of the energy storage component at a constant value.

In one embodiment, each discharging device further includes a bypass switch. The bypass switch is connected to the first series-connected branch in parallel. When the bypass switch is turned on and the switch is turned off, the bypass switch bypasses charging the energy storage component.

In one embodiment, before each energy storage component is charged in the constant-current manner, each controller controls each bypass switch and each switch so that the power supply first charge the energy storage component with a smaller remaining capacity, and until the remaining capacities of the energy storage components are the same, the energy storage components are charged in the constant-current manner.

Therefore, the charging/discharging system has the following features and advantages. 1. The output voltage of the battery can be accurately achieved through the constant-current charging manner and the constant-voltage discharging manner provided by the load unit. 2. The time required to charge batteries with similar characteristics from the same batch to a fixed voltage range can be shortened. 3. The switch and the bypass switch are first control to charge the energy storage component with lower power. Until the remaining battery capacities of the batteries are the same or similar (for example, the difference is less than 0.5%), the charging and discharging control can be then performed for the whole batteries to achieve energy saving effect. 4. The operation method of charging and then discharging a large number of batteries according to the present disclosure can achieve the same or higher output voltage concentration (i.e., reduce the voltage difference between batteries) in a shorter time than the traditional CC charging plus CV charging process, thereby reducing the time required to charge the battery to a fixed voltage.

Further another objective of the present disclosure is to provide a method of operating a discharging device. The discharging device discharges an energy storage component, and the discharging device includes a load unit coupled to the energy storage component. The method includes steps of: (a) charging the energy storage component in a constant-current manner, (b) determining whether a voltage of the energy storage component reaches a reference voltage, and (c) enabling the load unit to discharge the energy storage component to a fixed voltage in a constant-voltage manner when the voltage reaches the reference voltage corresponding to the discharging device.

In one embodiment, the method further includes a step of: (d) charging the energy storage component in a constant-voltage manner.

In one embodiment, when the voltage of the energy storage component reaches the reference voltage, the load unit is enabled to discharge the energy storage component to the fixed voltage in a constant-current manner instead of the constant-voltage manner.

Therefore, the method has the following features and advantages. 1. The output voltage of the battery can be accurately achieved through the constant-current charging manner and the constant-voltage discharging manner provided by the load unit. 2. The time required to charge batteries with similar characteristics from the same batch to a fixed voltage range can be shortened. 3. The switch and the bypass switch are first control to charge the energy storage component with lower power. Until the remaining battery capacities of the batteries are the same or similar (for example, the difference is less than 0.5%), the charging and discharging control can be then performed for the whole batteries to achieve energy saving effect. 4. The operation method of charging and then discharging a large number of batteries according to the present disclosure can achieve the same or higher output voltage concentration (i.e., reduce the voltage difference between batteries) in a shorter time than the traditional CC charging plus CV charging process, thereby reducing the time required to charge the battery to a fixed voltage.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a schematic waveform diagram of charging a battery in a constant-current manner and a constant-voltage manner.

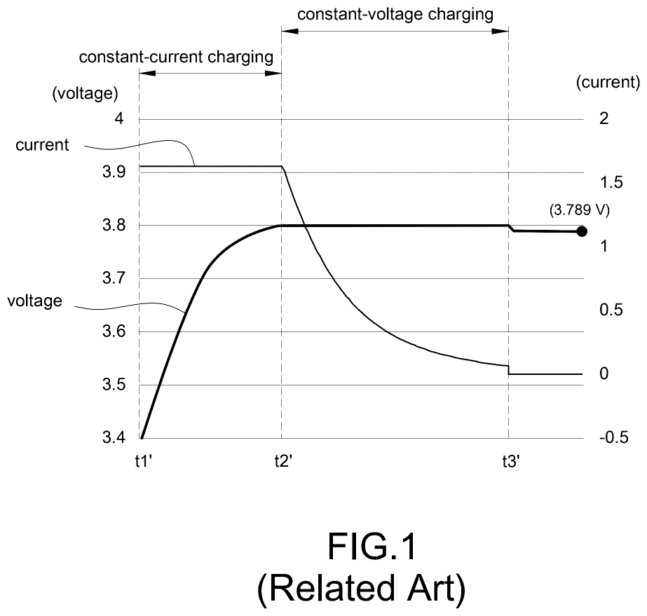

FIG. 2 is a block diagram of a discharging device according to the present disclosure.

FIG. 3A is a circuit diagram of a load unit of the discharging device according to a first embodiment of the present disclosure.

FIG. 3B is a circuit diagram of the load unit of the discharging device according to a second embodiment of the present disclosure.

FIG. 3C is a circuit diagram of the load unit of the discharging device according to a third embodiment of the present disclosure.

FIG. 4 is a block diagram of a charging/discharging system according to the present disclosure.

FIG. 5 is a schematic waveform diagram of an energy storage component charging in a constant-current manner and discharging in a constant-voltage manner according to the present disclosure.

FIG. 6 is a schematic waveform diagram of the energy storage component charging in a constant-current manner and a constant-voltage manner and discharging in a constant-voltage manner according to the present disclosure.

FIG. 7 is a schematic diagram of charging two energy storage components with the same remaining battery capacity according to the present disclosure.

FIG. 8 is a schematic diagram of charging two energy storage components with different remaining battery capacities according to the present disclosure.

FIG. 9 is a schematic block diagram of the energy storage component discharging according to the present disclosure.

FIG. 10A is a flowchart of a method of operating the discharging device according to a first embodiment of the present disclosure.

FIG. 10B is a flowchart of a method of operating the discharging device according to a second embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

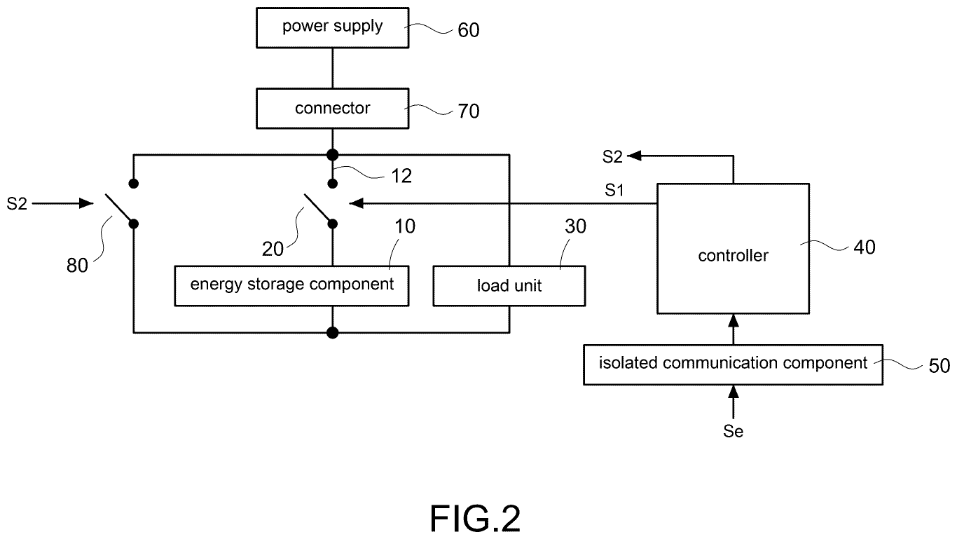

Please refer to FIG. 2, which shows a block diagram of a discharging device according to the present disclosure. As shown in FIG. 2, the discharging device is used to discharge an energy storage component 10. The discharging device includes a switch 20, a load unit 30, a controller 40, and an isolated communication component 50.

The switch 20 is connected to the energy storage component 10 in series to form a first series-connected branch 12. In particular, the energy storage component 10 may be a component of different energy storage forms (for example, mechanical energy storage, electrochemical energy storage, chemical energy storage, thermal energy storage, and electrical energy storage), and therefore any component with energy storage function should be included in the scope of the present disclosure. For example, but not limiting the present disclosure, the energy storage component 10 may be secondary batteries (lead-acid batteries, lithium batteries, etc.), supercapacitors, superconducting magnetic energy storage components, etc. The switch 20 is used to connect and disconnect the first series-connected branch 12, and the switch 20 may be a semiconductor switch, a relay, etc., but this does not limit the present disclosure.

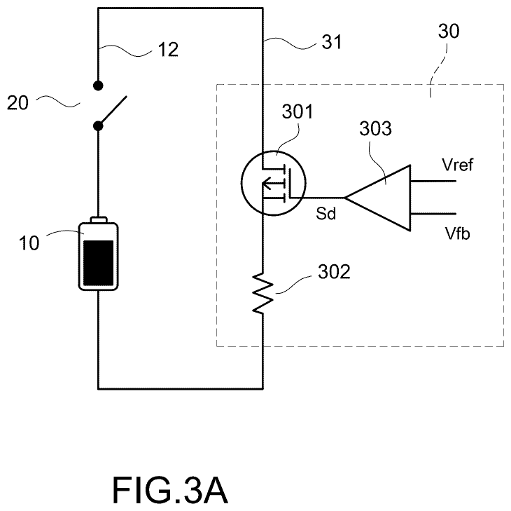

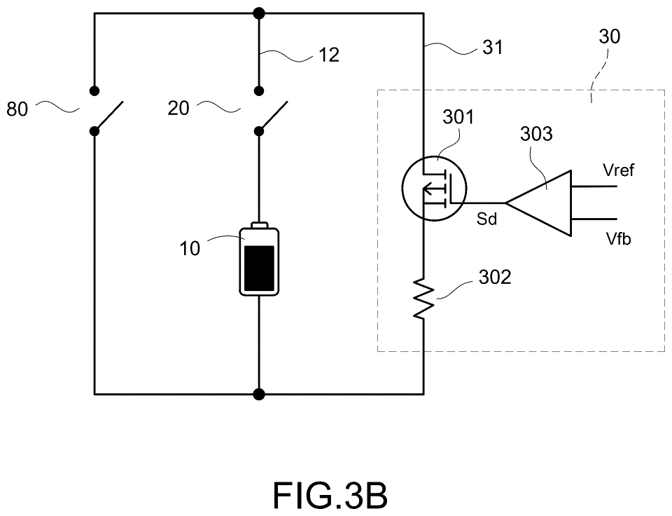

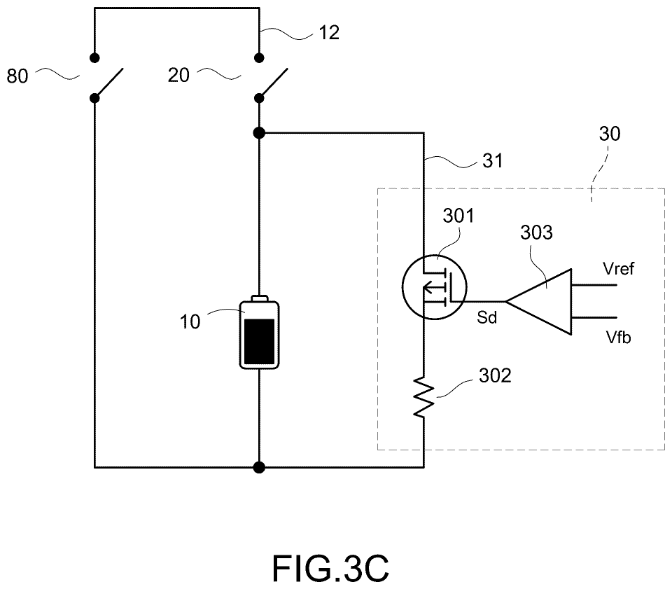

The load unit 30 is connected to the first series-connected branch 12 in parallel or is connected to the energy storage component 10 in parallel. Please refer to FIG. 3B, which shows a circuit diagram of the load unit of the discharging device according to a second embodiment of the present disclosure, that is, an embodiment in which the load unit 30 is connected to the first series-connected branch 12 in parallel. Take the load unit 30 shown in FIG. 3B as an example, the load unit 30 includes a switch component 301, a resistor component 302, and a feedback control unit 303. In the present disclosure, the load unit 30 is mainly used to maintain the voltage of the energy storage component 10 and provide a path required for discharging when the energy storage component 10 has excess current. Therefore, the load unit 30 may be called a constant-voltage load. Moreover, the load unit 30 may be implemented by a transistor and a feedback circuit. As shown in FIG. 3B, the resistor component 302 is connected to the switch component 301 in series to form a second series-connected branch 31, and the second series-connected branch 31 is connected to the first series-connected branch 12 in parallel. The feedback control unit 303 is connected to the switch component 301, and generates a load control signal Sd to control the switch component 301 to be turned on and turned off. Incidentally, in the present disclosure, the switch component 301 may be, for example but not limited to, a semiconductor switch, as shown in FIG. 3A to FIG. 3C. However, in different embodiments, other types of switch components may also be used, and therefore any switch component with turned-on and turned-off functions should be included in the scope of the present disclosure.

As shown in FIG. 3B, the feedback control unit 303 is an operational amplifier, which includes two input terminals. One input terminal receives a measured voltage Vfb of the energy storage component 10 (hereinafter referred to as a battery voltage Vfb), and the other terminal receives a reference voltage Vref. The feedback control unit 303 compare the battery voltage Vfb with the reference voltage Vref to control an impedance of the switch component 301. In other words, when the measured battery voltage Vfb of the energy storage component 10 reaches the reference voltage Vref, the feedback control unit 303 generates a driving signal Sd with a high level to decrease the impedance of the switch component 301, and therefore the energy storage component 10 provides a constant-voltage discharging operation. On the contrary, if the measured battery voltage Vfb of the energy storage component 10 is less than or equal to the reference voltage Vref, the feedback control unit 303 generates the driving signal Sd with a low level to increase the impedance of the switch component 301, and therefore the load unit 30 continuously provides the constant-voltage discharging operation. Alternatively, in the corresponding constant-current discharging operation, the energy storage component 10 is allowed to continuously provide the constant-current discharging operation.

In addition, since the load unit 30 will generate heat when discharging in the constant-voltage manner, the present disclosure can further detect the temperature of the load unit 30 and provide a heat sink for heat dissipation.

Please refer to FIG. 3C, which shows a circuit diagram of the load unit of the discharging device according to a third embodiment of the present disclosure, that is, an embodiment in which the load unit 30 is connected to the energy storage component 10 in parallel. Compared with the embodiment shown in FIG. 3B, the major difference between the two is that the load unit 30 shown in FIG. 3B is connected to the first series-connected branch 12 in parallel, while the load unit 30 shown in FIG. 3C is connected to the energy storage component 10 in parallel. Since the circuit components of the load unit 30 in FIG. 3B and FIG. 3C are the same, and the voltage determination methods are the same, they will not be described in detail here, and please refer to the above-mentioned content.

In addition, in addition to the two embodiments shown in FIG. 3B and FIG. 3C, the discharging device may omit the bypass switch 80, as shown in the embodiment shown in FIG. 3A. Therefore, it is also to implement a single discharging device to operate the energy storage component 10 to discharge by enabling the load unit 30. As for the specific operation, please refer to the previous description and will not be repeated here.

Please refer to FIG. 2 again, the controller 40 is coupled to the switch 20 for controlling the switch 20. In particular, the controller 40 generates a first control signal Sc to control the turning on and turning off of the switch 20, and described in detail later.

The isolated communication component 50 is connected to the controller 40, and the isolated communication component 50 receives an external control signal Se. In particular, the external control signal Se may be a voltage signal or a current signal, provided by an external device, such as a computer host device, and received through the isolated communication component 50. The controller 40 turns on the switch 20 according to the external control signal Se so that the energy storage component 10 is charged in the constant-current manner. Moreover, when the voltage (i.e., the battery voltage Vfb) of the energy storage component 10 reaches the reference voltage Vref, the load unit 30 is enabled (activated), and the energy storage component 10 is discharged to a fixed voltage Vx in a constant-voltage manner, thereby implementing charging and discharging of the energy storage component 10.

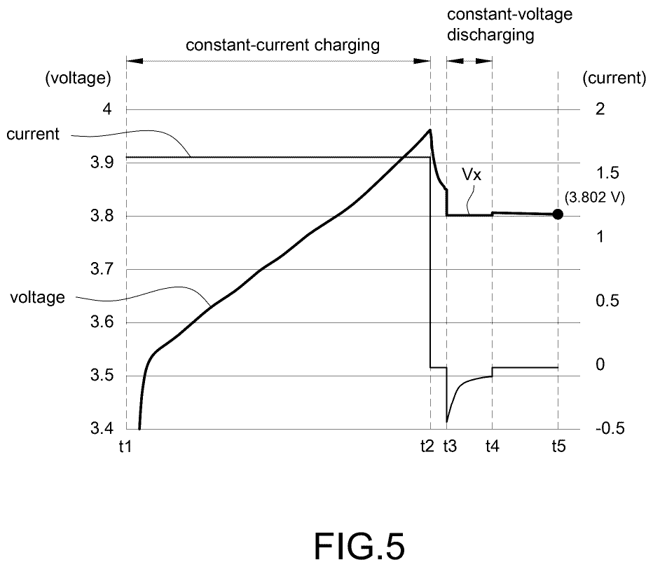

Please refer to FIG. 5, which shows a schematic waveform diagram of an energy storage component charging in a constant-current manner and discharging in a constant-voltage manner according to the present disclosure. Also refer to FIG. 2, in this embodiment, between time t1 and time t2, the controller 40 controls a power supply 60 to charge the energy storage component 10 according to the external control signal Se. Therefore, the controller 40 provides a first control signal S1 to control the switch 20 to be turned on. During this charging stage, the power supply 60 provides energy and power to the energy storage component 10 through the connector 70 to charge the energy storage component 10 in the constant-current manner, and therefore the voltage of the energy storage component 10 gradually increases. Until the voltage of the energy storage component 10 reaches a reference voltage (please refer to the previous description of FIG. 3B and FIG. 3C, which will not be described again), the load unit 30 is enabled to perform the constant-voltage discharging operation.

In particular, according to the previous description, at time t2 in FIG. 5, the load unit 30 performs the constant-voltage discharging operation. However, an idle time interval may be introduced between time t2 and time t3, that is, during the idle time interval, the energy storage component 10 cannot be charged or discharged. At the end of the idle time interval, that is, at time t3, the load unit 30 is enabled to performs the constant-voltage discharging operation. Therefore, a buffer can be provided between constant-current charging and constant-voltage discharging to achieve stable and accurate constant-voltage discharging operation. In particular, during the constant-current charging process, the voltage of the energy storage component 10 is less than a fully-charged voltage of the energy storage component 10. For example, if a voltage of the energy storage component 10 when fully charged (i.e., the full-charged voltage) is 4.2 volts, at time t2, the voltage of the energy storage component 10 (the maximum voltage during constant-current charging) will be less than 4.2 volts.

Afterward, between time t3 and time t4, according to the comparison between the battery voltage Vfb of the energy storage component 10 and the reference voltage Vref (see FIG. 3B or FIG. 3C), when the measured battery voltage Vfb of the energy storage component 10 reaches the reference voltage Vref, the feedback control unit 303 generates the driving signal Sd with a high level to turn on the switch component 301 to enable (activate) the load unit 30 so that the excess energy of the energy storage component 10 is discharged to a fixed voltage Vx (for example, but not limited to, 3.802 volt) by a constant-voltage manner through the load unit 30. In particular, during the constant-voltage discharging process, the energy storage component 10 is first controlled in a negative current, and then the value of the negative current is gradually increased until the current value is close to zero to complete the constant-voltage discharging process. In addition, the constant-voltage discharging process between time t3 and time t4 may also be replaced by the constant-current discharging process, and the discharging process ends when the energy storage component 10 is discharged to a target voltage (i.e., the fixed voltage Vx), which will not be described again.

At time t4, the constant-voltage discharging is completed. However, due to the battery ion concentration distribution characteristics of the energy storage component 10, after the constant-voltage discharging is completed, the voltage of the energy storage component 10 may increase slightly. Moreover, after time t5, a quality control stage is entered (introduced), for example, but not limited to, within 6 hours (between time t4 and time t5), the voltage of the energy storage component 10 is detected (monitored) as a basis for quality control. During the quality control stage, if the voltage of the energy storage component 10 is within a required range, the charging process is completed.

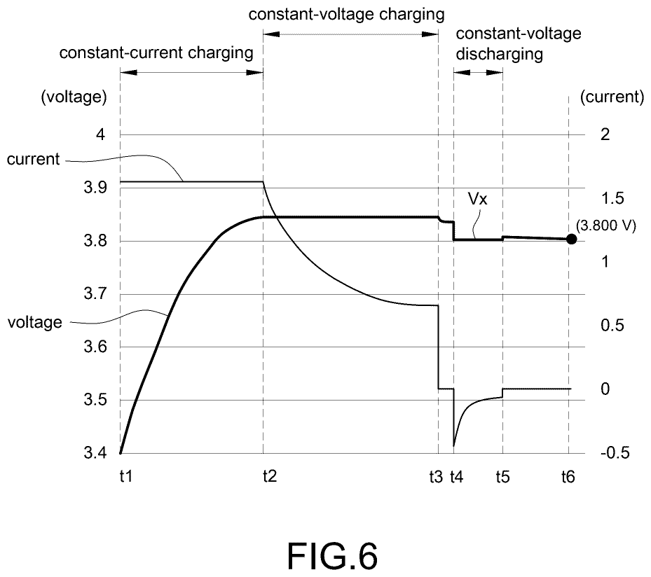

Please refer to FIG. 6, which shows a schematic waveform diagram of the energy storage component charging in a constant-current manner and a constant-voltage manner and discharging in a constant-voltage manner according to the present disclosure. In this embodiment, between time t1 and time t2, the controller 40 controls a power supply 60 to charge the energy storage component 10 according to the external control signal Se. Therefore, the controller 40 provides a first control signal S1 to control the switch 20 to be turned on. During this charging stage, the power supply 60 provides energy and power to the energy storage component 10 through the connector 70 to charge the energy storage component 10 in the constant-current manner, and therefore the voltage of the energy storage component 10 gradually increases. Until time t2, the power supply 60 charges the energy storage component 10 in the constant-voltage manner. Until the voltage of the energy storage component 10 reaches a reference voltage (please refer to the previous description of FIG. 3B and FIG. 3C, which will not be described again), the load unit 30 is enabled to perform the constant-voltage discharging operation. In addition, the constant-voltage discharging process between time t4 and time t5 may also be replaced by the constant-current discharging process, that is, when the voltage of the energy storage component 10 reaches the reference voltage, the energy storage component 10 provides a constant-voltage discharging operation, and the discharging process ends when the energy storage component 10 is discharged to a target voltage (i.e., the fixed voltage Vx), which will not be described again.

In particular, according to the previous description, at time t3 in FIG. 6, the load unit 30 performs the constant-voltage discharging operation. However, an idle time interval may be introduced between time t3 and time t4, that is, during the idle time interval, the energy storage component 10 cannot be charged or discharged. At the end of the idle time interval, that is, at time t4, the load unit 30 is enabled to performs the constant-voltage discharging operation. Therefore, a buffer can be provided between constant-current charging and constant-voltage discharging to achieve stable and accurate constant-voltage discharging operation.

Afterward, between time t4 and time t5, according to the comparison between the battery voltage Vfb of the energy storage component 10 and the reference voltage Vref (see FIG. 3B or FIG. 3C), when the measured battery voltage Vfb of the energy storage component 10 reaches the reference voltage Vref, the feedback control unit 303 generates the driving signal Sd with a high level to decrease the impedance of the switch component 301 so as to enable (activate) the load unit 30 so that the excess current can be consumed through the load unit 30 to provide the constant-voltage discharging when the energy storage component 10 is maintained at a constant-voltage condition. Therefore, the energy storage component 10 is discharged to the fixed voltage Vx (for example, but not limited to, 3.800 volt). In particular, during the constant-voltage discharging process, the energy storage component 10 is first controlled in a negative current, and then the value of the negative current is gradually increased until the current value is close to zero to complete the constant-voltage discharging process. Alternatively, the constant-voltage discharging process may also be replaced by the constant-current discharging process, i.e., the energy storage component 10 provides the constant-current discharging operation to discharge to the fixed voltage Vx.

At time t5, the discharge of the energy storage component 10 is completed. However, due to the battery ion concentration distribution characteristics of the energy storage component 10, after the constant-voltage discharging is completed, the voltage of the energy storage component 10 may increase slightly. Moreover, after time t6, a quality control stage is entered (introduced), for example, but not limited to, within 6 hours (between time t5 and time t6), the voltage of the energy storage component 10 is detected (monitored) as a basis for quality control. During the quality control stage, if the voltage of the energy storage component 10 is within a required range, the charging process is completed.

As for the energy storage component 10, as shown in FIG. 2, the energy storage component 10 is charged through an external power supply 60. Moreover, the discharging device further includes a connector 70, and the connector 70 is connected between the power supply 60 and the energy storage component 10. Therefore, the power supply 60 provides energy and power to the energy storage component 10 through the connector 70 to charge the energy storage component 10.

As shown in FIG. 2, the discharging device further includes a bypass switch 80, and the bypass switch 80 is connected to first series-connected branch 12 in parallel. When the bypass switch 80 is turned on and the switch 20 is turned off, the bypass switch 80 is used to bypass the charging operation of the energy storage component 10, that is, the energy and power provided by the power supply 60 will no longer charge the energy storage component 10 through the switch 20, but will be bypassed through the bypass switch 80. Specifically, the controller 40 generates a second control signal S2 to turn on and turn off the bypass switch 80.

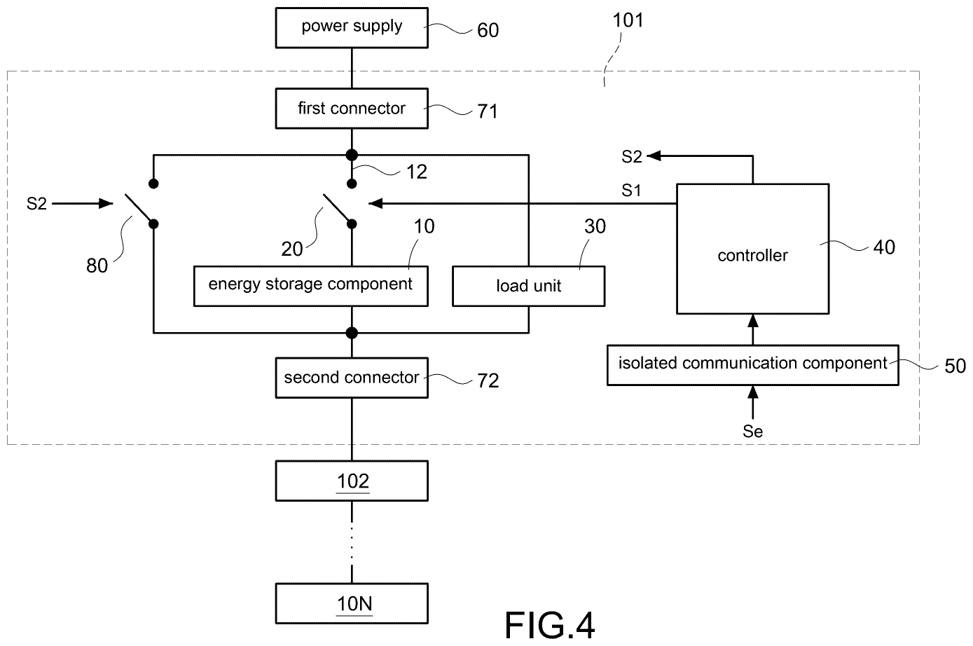

Please refer to FIG. 4, which shows a block diagram of a charging/discharging system according to the present disclosure. As shown in FIG. 4, the charging/discharging system includes a plurality of discharging devices 101-10N shown in FIG. 2. In particular, in addition to the switch 20, the load unit 30, the controller 40, the isolated communication component 50, and the bypass switch 80, each discharging device 101-10N further includes two connectors 71,72, i.e., a first connector 71 and a second connector 72. For the first discharging device 101, the first connector 71 of the first discharging device 101 is used to connect the discharging device and the power supply 60, and the second connector 72 of the first discharging device 101 is used to connect the next discharging device, i.e., the second discharging device 102. For the second discharging device 102, the first connector 71 of the second discharging device 102 is used to connect the second connector 72 of the first discharging device 101, and the second connector 72 of the second discharging device 102 is used to connect the next discharging device, i.e., a third discharging device (not shown). Similarly, the first connector 71 of the Nth discharging device 10N is used to connect the second connector 72 of the (N−1)th discharging device so as to form a series-connected power path.

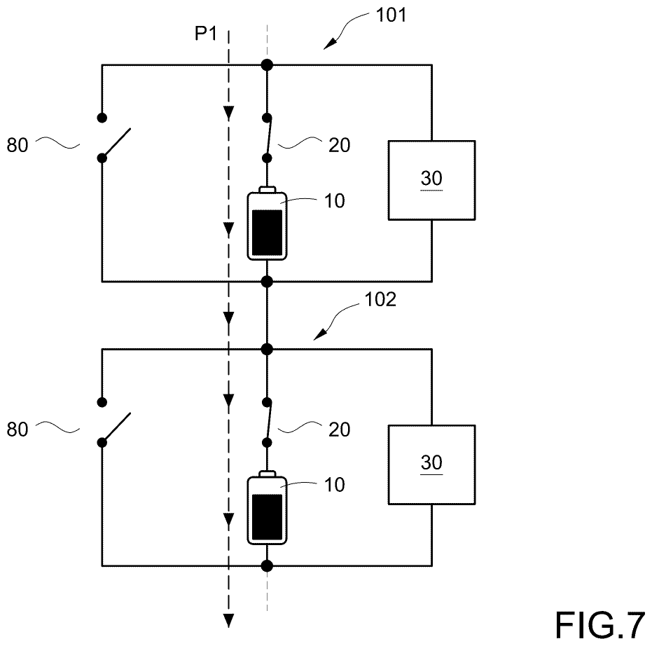

Please refer to FIG. 7, which shows a schematic diagram of charging two energy storage components with the same remaining battery capacity according to the present disclosure. Two discharging devices, namely the first discharging device 101 and the second discharging device 102 are taken as an example for explanation. In this operating scenario, since the remaining battery capacity (which can be represented by SOC, battery state of charge) of the energy storage component 10 of the first discharging device 101 is similar to the remaining battery capacity of the energy storage component 10 of the second discharging device 102, or there is not much difference. Therefore, the energy storage components 10 of the two discharging devices 101,102 can be charged and discharged simultaneously. As shown in FIG. 7, the controller 40 of each discharging device 101, 102 respectively controls the switches 20 to be turned on, and therefore the energy and power provided by the power supply 60 will directly and sequentially charge the energy storage component 10 of the first discharging device 101 and the energy storage component 10 of the second discharging device 102. That is, the energy and power provided by the power supply 60 flow through a first power path P1 to charge the two energy storage components 10. As for the discharging operation of the energy storage component 10 of each discharging device 101,102, please refer to the previous description and will not be repeated here.

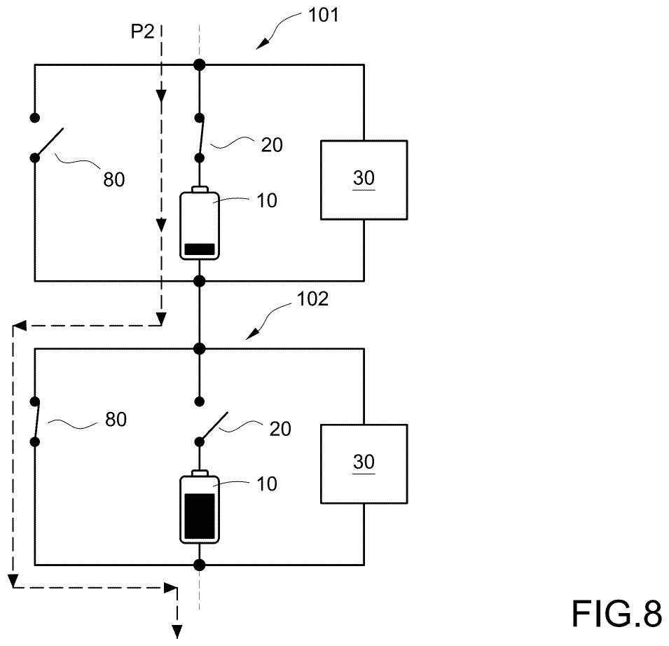

Please refer to FIG. 8, which shows a schematic diagram of charging two energy storage components with different remaining battery capacities according to the present disclosure. Two discharging devices, namely the first discharging device 101 and the second discharging device 102 are taken as an example for explanation. Different from the operating scenario of FIG. 7, the remaining battery capacity of the energy storage component 10 of the first discharging device 101 shown in FIG. 8 is quite different from the remaining battery capacity of the energy storage component 10 of the second discharging device 102, that is, the energy storage capacities of the two energy storage components 10 are unbalanced. For example, the remaining battery capacity of the energy storage component 10 of the first discharging device 101 is much lower than the remaining battery capacity of the energy storage component 10 of the second discharging device 102. If charging is performed using the operation manner shown in FIG. 7, both energy storage components 10 will reach the same battery voltage after a period of time. However, obviously, when the energy storage component 10 of the second discharging device 102 reaches the battery voltage first, the energy storage component 10 of the first discharging device 101 is still charging. Therefore, the excess current of the energy storage component 10 of the second discharging device 102 will be released to the load unit 30 of the second discharging device 102 first, which will cause the second discharging device 102 to have higher energy consumption.

Therefore, in order to solve the problem of higher energy consumption caused by the large difference in the remaining battery capacity of the batteries, the battery with the smaller remaining battery capacity can be charged first. In this embodiment, the energy storage component 10 of the first discharging device 101 is charged first. Until the remaining battery capacity of the battery is the same or similar to that of the other one (i.e., the energy storage component 10 of the second discharging device 102), the energy storage components 10 of the two discharging devices 101,102 are charged or discharged at the same time, thereby reducing energy consumption.

For example, as shown in FIG. 8, the controller 40 of the first discharging device 101 controls the switch 20 of the first discharging device 101 to be turned on, and controls the bypass switch 80 of the first discharging device 101 to be turned off, while the controller 40 of the second discharging device 102 controls the switch 20 of the second discharging device 102 to be turned off and controls the bypass switch 80 of the second discharging device 102 to be turned on. Therefore, the energy and power provided by the power supply 60 will only charge the energy storage component 10 (low power) of the first discharging device 101, but will not charge the energy storage component 10 (high power) of the second discharging device 102. That is, the energy and power provided by the power supply 60 flow through a second power path P2 to charge the energy storage component 10 of the first discharging device 101. Until the remaining battery capacity of the energy storage component 10 of the first discharging device 101 is the same or similar to that of the other one (i.e., the energy storage component 10 of the second discharging device 102), the energy storage components 10 of the two discharging devices 101, 102 are then charged or discharged at the same time, that is, the operating scenario as shown in FIG. 7 can achieve energy saving effect. As for the discharging operation of the energy storage component 10 of each discharging device 101,102, please refer to the previous description and will not be repeated here.

Therefore, if the energy storage components of a plurality of discharging devices have different remaining battery capacities, the turning-on and turning-off of the corresponding switches 20 and the turning-on and turning-off of the bypass switch 80 can be controlled so that the energy storage components can receive the energy provided by the power supply 60, or the energy provided by the power supply 60 is bypassed. Therefore, when the remaining battery capacities of these energy storage components are the same or similar (for example, the difference is less than 0.5%), the charging and discharging control can be then performed to achieve energy saving effect. Incidentally, since the information of the remaining battery capacity of the energy storage components can be acquired, and the charging current provided by the charging time is known, the charging capacity can also be accurately calculated so that the remaining battery capacities of the energy storage components are the same, which can also be easily achieved in the present disclosure.

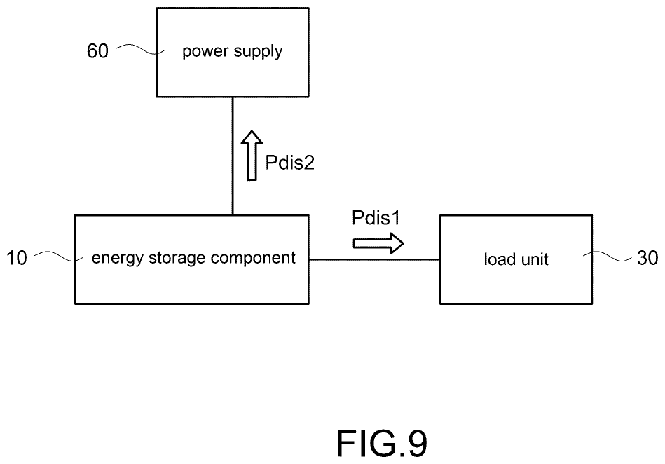

Please refer to FIG. 9, which shows a schematic block diagram of the energy storage component discharging according to the present disclosure. In addition to allowing part of the excess electric energy of the energy storage component 10 (i.e., a first discharging energy Pdis1) to be discharged in a constant-voltage manner through the load unit 30, another part of electric energy (i.e., a second discharging energy Pdis2) can be fed back to the power supply 60 so that the electric energy usage efficiency can be increased by recycling the electric energy.

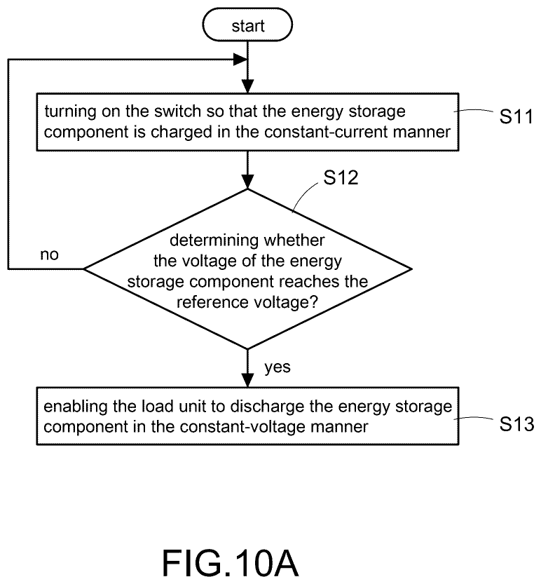

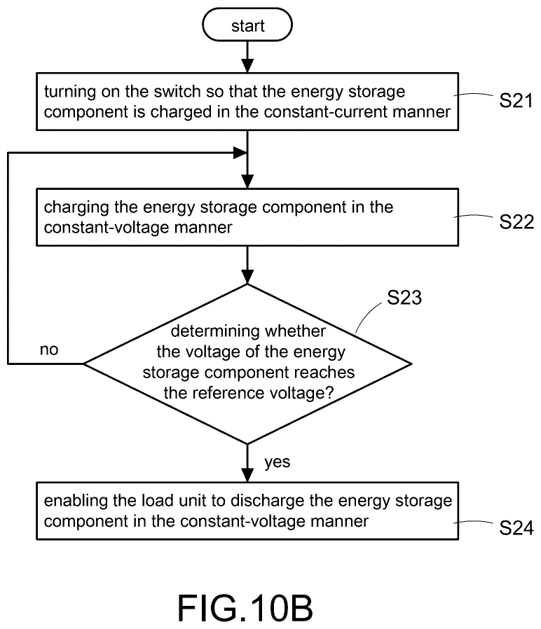

Please refer to FIG. 10A and FIG. 10B, which show flowcharts of a method of operating the discharging device according to a first embodiment and a second embodiment of the present disclosure respectively. As shown in FIG. 10A, the method includes steps of: turning on the switch so that an energy storage component is charged in the constant-current manner (step S11). Afterward, determining whether a voltage of the energy storage component reaches the reference voltage (step S12). If the voltage does not reach the reference voltage, step S11 is performed. If the voltage reaches the reference voltage of the corresponding discharging device, enabling the load unit to charge or discharge the energy storage component in a constant-voltage manner at the fixed voltage (step S13). As for the specific description of the discharging device, please refer to the previous disclosure and will not be repeated here. As for the second embodiment shown in FIG. 10B, the main difference from the first embodiment shown in FIG. 10A is that between step S21 (corresponding to step S11 of FIG. 10A) and step S23 (corresponding to step S12 of FIG. 10A), further including a step of: charging the energy storage component in a constant-voltage manner (step S22). In the determination of step S23, if the voltage does not reach the reference voltage, step S22 is performed. If the voltage reaches the reference voltage of the corresponding discharging device, enabling the load unit to charge or discharge the energy storage component in the constant-voltage manner at the fixed voltage (step S24).

In summary, the present disclosure has the following features and advantages:

1. The output voltage of the battery can be accurately achieved through the constant-current charging manner and the constant-voltage discharging manner provided by the load unit.

2. The time required to charge batteries with similar characteristics from the same batch to a fixed voltage range can be shortened.

3. The switch 20 and the bypass switch 80 are first control to charge the energy storage component with lower power. Until the remaining battery capacities of the batteries are the same or similar (for example, the difference is less than 0.5%), the charging and discharging control can be then performed for the whole batteries to achieve energy saving effect.

4. The operation method of charging and then discharging a large number of batteries according to the present disclosure can achieve the same or higher output voltage concentration (i.e., reduce the voltage difference between batteries) in a shorter time than the traditional CC charging plus CV charging process, thereby reducing the time required to charge the battery to a fixed voltage.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A discharging device, comprising:
an energy storage component, and
a load unit, coupled to the energy storage component,
wherein the energy storage component is charged in a constant-current manner, and when a voltage of the energy storage component reaches a reference voltage, the load unit is enabled to discharge the energy storage component to a fixed voltage in a constant-voltage manner.

2. The discharging device as claimed in claim 1, further comprising:
a switch, connected to the energy storage component in series to form a first series-connected branch, wherein the load unit is connected to the first series-connected branch in parallel, or is connected to the energy storage component in parallel,
a controller, coupled to the switch, and
an isolated communication component, connected to the controller, and the isolated communication component configured to receive an external control signal,
wherein the controller is configured to turn on the switch according to the external control signal so that the energy storage component is charged in the constant-current manner.

3. The discharging device as claimed in claim 1, wherein the energy storage component is charged by a power supply.

4. The discharging device as claimed in claim 1, wherein after the energy storage component is charged in the constant-current manner for a time period, when the voltage of the energy storage component reaches the reference voltage corresponding to the discharging device, the load unit is enabled to charge or discharge the energy storage component in the constant-voltage manner at the fixed voltage.

5. The discharging device as claimed in claim 1, wherein when the voltage of the energy storage component reaches the reference voltage, the load unit is enabled to discharge the energy storage component to the fixed voltage in a constant-current manner instead of the constant-voltage manner.

6. The discharging device as claimed in claim 1, wherein during the energy storage component charged in the constant-current manner, the voltage of the energy storage component is less than a fully-charged voltage of the energy storage component.

7. The discharging device as claimed in claim 2, wherein the load unit comprises:
a switch component,
a resistor component, connected to the switch component in series, and
a feedback control unit, connected to the switch component, and configured to generate a load control signal to control the switch component.

8. The discharging device as claimed in claim 7, wherein the feedback control unit is configured to receive the voltage of the energy storage component and the reference voltage, and compare the voltage with the reference voltage,
wherein the load control signal controls an impedance of the switch component to maintain the voltage of the energy storage component at a constant value.

9. The discharging device as claimed in claim 2, further comprising:
a bypass switch, connected to the first series-connected branch in parallel,
wherein when the bypass switch is turned on and the switch is turned off, the bypass switch is configured to bypass charging the energy storage component.

10. A charging/discharging system, comprising:
a plurality of discharging devices and a plurality of energy storage components, connected in series with each other, each discharging device configured to discharge each energy storage component, each discharging device comprising:
a switch, connected to the energy storage component in series to form a first series-connected branch,
a load unit, connected to the first series-connected branch in parallel, or connected to the energy storage component in parallel,
a controller, coupled to the switch, and
an isolated communication component, connected to the controller, and the isolated communication component configured to receive an external control signal,
wherein the controller is configured to turn on the switch according to the external control signal so that the energy storage component is charged in a constant-current manner, and when a voltage of the energy storage component reaches a reference voltage, the load unit is enabled to discharge the energy storage component to a fixed voltage in a constant-voltage manner.

11. The charging/discharging system as claimed in claim 10, wherein the energy storage component is charged by a power supply.

12. The charging/discharging system as claimed in claim 10, wherein after each energy storage component is charged in the constant-current manner for a time period, when the voltage of each energy storage component reaches the reference voltage corresponding to the discharging device, the load unit is enabled to charge or discharge the energy storage component in the constant-voltage manner at the fixed voltage.

13. The charging/discharging system as claimed in claim 10, wherein when the voltage of the energy storage component reaches the reference voltage, the load unit is enabled to discharge the energy storage component to the fixed voltage in a constant-current manner instead of the constant-voltage manner.

14. The charging/discharging system as claimed in claim 11, wherein each discharging device further comprises:
two connectors, one of the two connectors connected to the power supply and the energy storage component, and the other of the two connectors connected to other discharging devices.

15. The charging/discharging system as claimed in claim 10, wherein each load unit comprises:
a switch component,
a resistor component, connected to the switch component in series, and
a feedback control unit, connected to the switch component, and configured to generate a load control signal to control the switch component.

16. The charging/discharging system as claimed in claim 15, wherein the feedback control unit is configured to receive the voltage of the energy storage component and the reference voltage, and compare the voltage with the reference voltage,
wherein the load control signal controls an impedance of the switch component to maintain the voltage of the energy storage component at a constant value.

17. The charging/discharging system as claimed in claim 11, wherein each discharging device further comprises:
a bypass switch, connected to the first series-connected branch in parallel,
wherein when the bypass switch is turned on and the switch is turned off, the bypass switch is configured to bypass charging the energy storage component,
wherein before each energy storage component is charged in the constant-current manner, each controller is configured to control each bypass switch and each switch so that the power supply first charge the energy storage component with a smaller remaining capacity, and until the remaining capacities of the energy storage components are the same, the energy storage components are charged in the constant-current manner.

18. A method of operating a discharging device, the discharging device configured to discharge an energy storage component, the discharging device comprising a load unit coupled to the energy storage component, the method comprising steps of:
(a) charging the energy storage component in a constant-current manner,
(b) determining whether a voltage of the energy storage component reaches a reference voltage, and
(c) enabling the load unit to discharge the energy storage component to a fixed voltage in a constant-voltage manner when the voltage reaches the reference voltage corresponding to the discharging device.

19. The method of operating the discharging device as claimed in claim 18, wherein between step (a) and step (b), further comprising a step of:
(d) charging the energy storage component in a constant-voltage manner.

20. The method of operating the discharging device as claimed in claim 18, wherein when the voltage of the energy storage component reaches the reference voltage, the load unit is enabled to discharge the energy storage component to the fixed voltage in a constant-current manner instead of the constant-voltage manner.
